(19) United States
(12) Patent Application Publication
(10) Pub. No.: US 2004/0031188 A1
(43) Pub. Date: Feb. 19, 2004

(54) Multifunction apparatus for fishing

(76) Inventor: Randle Lee Dugger, Oildale, CA (US)

Correspondence Address: Randle L. Dugger II, 119 Harding Ave., Oildale, CA, 93308, US

(21) Appl. No.: 10/223,896

(22) Filed: Aug. 19, 2002

(51) Int. Cl. A01K 91/00; A01K 93/00; A01K 95/00

(52) U.S. Cl. 43/44.91

(57) ABSTRACT

The disclosed apparatus is attachable to a fishing line between the fishing reel and the hook. The apparatus makes it easier for an angler to jig the bait and set the hook because the user may manipulate their lure or bait without having to move sinkers through the water.

One embodiment of the invention comprises a shell having a first half attached to a second half with a hinge and fastening means. The first half has a first interior wall and the second half has a second interior wall. The shell has openings for passing fishing line into and out of the shell. A first axle is attached to the first interior wall. A pulley is rotatably mounted on the first axle, where the pulley has a peripheral surface adapted for engaging the fishing line. A second axle is attached to the first interior wall adjacent to the pulley, where an idler wheel is rotatably mounted on the second axle. The idler wheel engages the peripheral surface of the pulley. Spring means engage the pulley, in which the spring means are placed in a tightened position when the pulley is rotated in a first direction. However, the spring means are not tightened when the pulley is rotated in a direction opposite to the first direction. Guiding means guide the fishing line through the shell to the pulley.

### BACKGROUND OF THE INVENTION

The present invention relates generally to fishing tackle and more specifically to an apparatus for assisting an angler by allowing quick and easy adjustment of sinker weight and the sinkers possession on the fishing line; secondly the apparatus allows quick and easy adjustment of the length of the leader; third the apparatus assists an angler in jigging by allowing the angler to manipulate the bait or lure independently of the sinker; the instant invention accomplishes these tasks without the need to cut or tie knots in the fishing line; at the same time the invention may increase the sensitivity of a fish nibbling or striking at a lure or bait.

The apparatus is submerged on the fishing line between the fishing reel and the hook. The apparatus itself may serve as a sinker, or additional weight may be added to the device according the desire of the user. The device may also be used to assist a user in casting where the user desires a long leader between the sinker and the hook.

It is well known to use sinkers to place bait or lures at a desired depth, or to hold bait or lures at a given location on the bottom. Typically the sinkers are tied to the fishing line itself. A substantial amount of weight may be required to place and hold bait or lures at a desired depth. The amount of weight required depends upon several factors, including the type fishing line, the type lure or bait used and the current of the water. However, tying this weight directly to the fishing line has several disadvantages. In some instances a technique is used to attract fish known as “jigging” in the art of jigging every individual angler adds his or her on subtle nuances to individualize there fishing style but they all have one thing in common, they must raise and lower the pole repeatedly in an attempt to either simulate live pray or something trying to invade the game fishes territory, tying weight directly to the line inhibits an angler ability to move the bait or lure in the manor desired and can be quite tiring over along periods of time, particularly if substantial amounts of weight are tied directly to the fishing line. Another disadvantage is that the use of weights tied directly to the fishing line makes it difficult for an angler to feel a small nibble or strike at the bait or lure. Moreover, having weight tied on the fishing line can make to more difficult to land a fish. As the fish runs, it has to pull the sinker along with it, in the case of some game fish like tuna the initial burst of speed may exceed thirty miles per hour pulling a sinker through a medium as viscose as water at that speed, even for a short distance puts tremendous strain on the line and hook and often contributes to the loss of the fish. The instant invention solves this problem by allowing the line to freely travel through it in the direction of the hook.

Conventional sinkers also make fishing difficult when trolling or in fast running currents, where the fishing line approaches a horizontal orientation with respect to the surface of the water. To jig a lure or bait, and or to set a hook once a fish has bitten the fisherman must not only overcome the weight of the sinker, but also the load caused by the force of the water acting on the surface area of the sinker.

Sometimes an angler will desire to have considerable distance between the sinker and the bait or lure, to date this distance is provided by either tying a secondary leader line onto the main line or by placing some kind of slip sinker on the main line and securing some type of stop to the line at the point the angler would like the sinker to stop. However, the use of a long leader can make casting difficult if not impossible, and may pose considerable risk to the angler or innocent bystanders in that controlling a hook, tied on a line several feet below a weight proves to be difficult if not impossible. The present invention solves this problem by allowing the angler to place the weight on the line approximately the desired location and then pull it down the fishing line in close proximity to the hook, allowing for a much safer and more accurate cast. After the cast the invention moves back up the fishing line to approximately its starting point.

### SUMMARY OF THE INVENTION

The present invention is directed to an apparatus which meets the needs identified above. The present invention enables a user to jig with less effort. It allows the user to have greater sensation of fish nibbling or striking bait or a lure and makes it easier for the user to set the hook. One embodiment of the device allows the user to place the device, including the desired weight, directly adjacent to the hook while casting. After the line is cast, the device automatically changes its position on the fishing line, to allow for the desired amount of leader between the hook and the weight.

The disclosed apparatus is attachable to a fishing line between the fishing reel and the hook. The apparatus either directly functions as a sinker, or the apparatus has means for adding weight to the apparatus, such as conventional fishing weights. The apparatus makes it easier for a person fishing to jig their bait or lure because the user may manipulate their lure or bait without having to move the weight through the water, In addition, one embodiment of the disclosed apparatus, enables an angler to fish with a long leader, without having to cast one.

One embodiment of the disclosed apparatus comprises a shell having a first wall, with a first axle attached to the first wall. A pulley is rotatably mounted on the first axle; the pulley has a peripheral surface at the bottom of the grooved rim adapted for engaging the fishing line. A second axle is attached to the first interior wall adjacent to the pulley; and idler wheel is rotatably mounted on the second axle. The idler wheel engages the peripheral surface at the bottom of the grooved rim of the pulley. Spring means engage the pulley. The spring means are placed in a tightened position when the pulley is rotated in a first direction. However, the spring is not tightened when the pulley is rotated in direction opposite to the first direction. Guiding means guide the fishing line along the first wall to the pulley. The user wraps the fishing line around the pulley and engages the fishing line between the idler wheel and the pulley.

Another embodiment of the present invention comprises a shell having a first half attached to a second half by means of a hinge on one side and a conventional clasping device on the other. The first half has a first interior wall and the second half has a second interior wall. The shell has openings for passing fishing line through the shell. A first axle is either solidly or rotatably mounted to the first interior wall. A pulley is either solidly or rotatably mounted on the first axle, where the pulley has a peripheral surface adapted for engaging the fishing line at the bottom of the grooved rim. A second axle is either attached to the first interior wall, or rotatably attached to the first interior wall adjacent to the pulley, where an idler wheel is either solidly mounted or rotatably mounted on the second axle. The idler wheel engages the peripheral surface of the pulley. A clock spring engages the pulley, in which the spring is placed in a tightened position when the pulley is rotated in a first direction. However, the spring is not tightened when the pulley is rotated in a direction opposite the first direction. Guiding means guide the fishing line through the shell to the pulley so that the user may wrap the fishing line around the pulley and engage the fishing line between the idler wheel and the pulley.

Additional embodiments of the apparatus are disclosed. In one of these embodiments, the idler wheel is mounted on an idler wheel arm, which is mounted on the second axle. The idler wheel arm has a pivot end and a wheel end, the pivot end is pivotally mounted on the second axle and the idler wheel is mounted on the wheel end. In another embodiment, the apparatus further comprises latching means for temporarily restraining the pulley. This feature allows a user to set the device at a first position on the fishing line, move the device down the fishing line to a second position on the line in close proximity to the hook, thereby tightening the spring attached to the pulley. The latching means are then used to temporarily set the device at the second position. However, when the bait or lure and the device is cast, the force of the cast causes the latch to disengage and the spring tension causes the device to move back to approximately the first position.

These and other features, aspects, and advantages of the present invention will become better understood with regard to the following description, appended claims, and accompanying drawings.

### BRIEF DESCRIPTION OF THE DRAWING

FIG. 1 is a partially exploded view of one embodiment of the disclosed device.

FIG. 2 is an exploded view of one embodiment of the disclosed device.

FIG. 3 is a front view of the first interior wall of the first half of the shell of one embodiment.

FIG. 4 is a front view of the first interior wall of the second half of the shell of one embodiment.

FIG. 5 is a perspective view of the pulley of the disclosed apparatus.

FIG. 6 is a detailed view of the offset in the fishing line guides.

FIG. 7 is a detailed view of the pulley, clock work spring, idler wheel, idler pivot arm, idler wheel tensioning spring and pulley locking device.

FIG. 8 is an exploded view of the pulley, clock work spring, idler wheel, idler pivot arm, idler wheel tensioning spring and pulley locking device.

FIG. 9 shows one embodiment of the guiding means for guiding the fishing line onto the pulley and a means of securing one end of the clockworks spring.

FIG. 10 shows an alternative embodiment of the disclosed invention.

FIG. 11 shows an exploded view of the alternative embodiment.

FIG. 12 shows the disclosed inventions assembled and open, with fishing line attached.

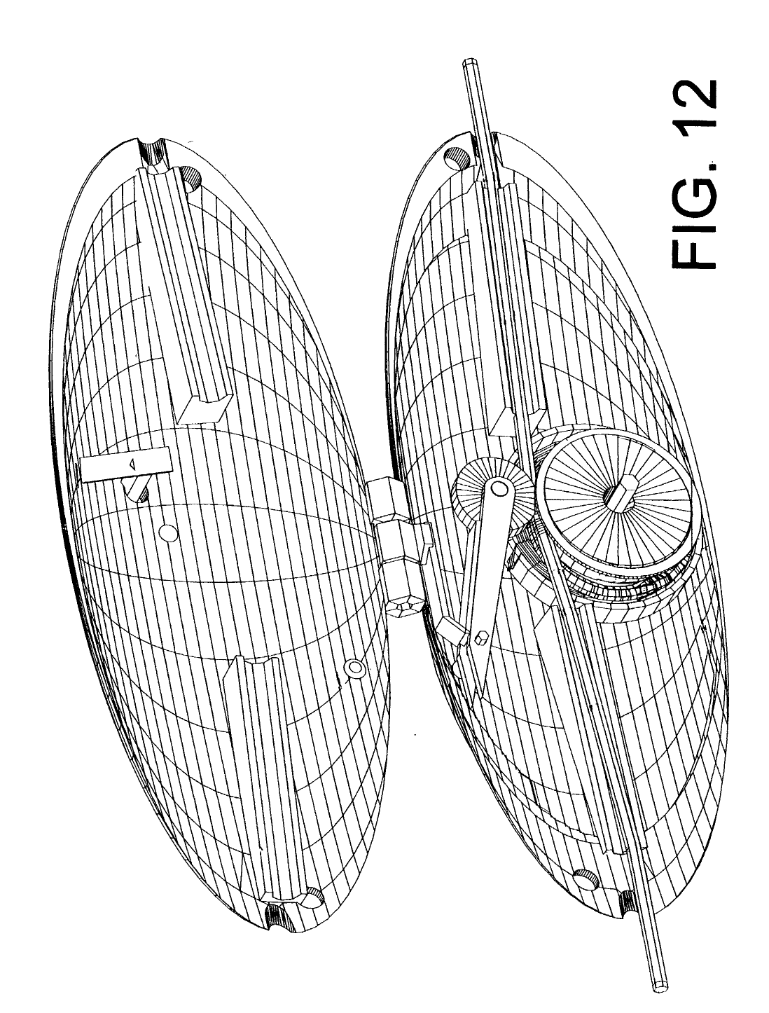

FIG. 13 shows the disclosed invention assembled and closed, without fishing line.

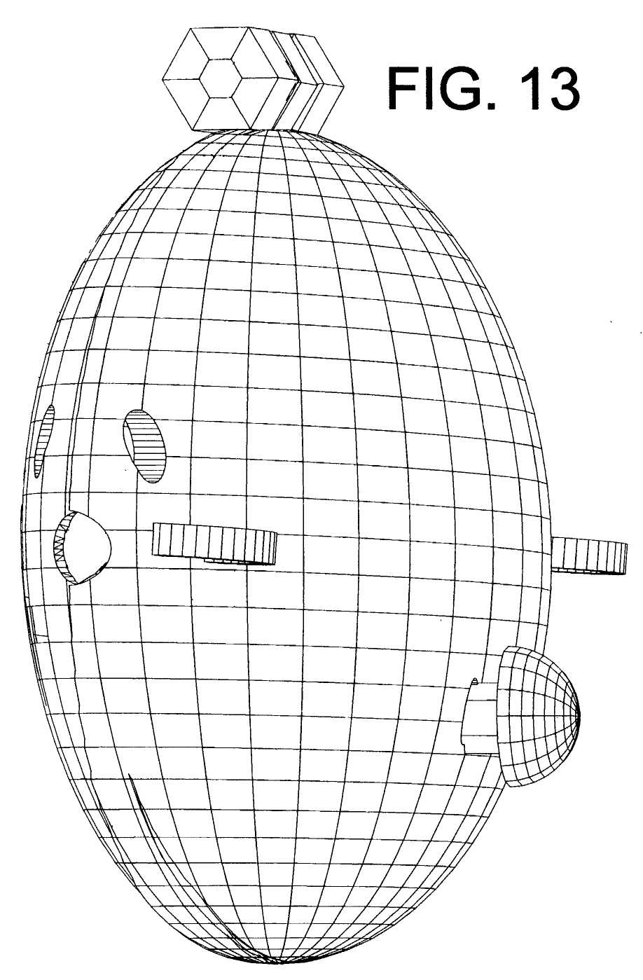

### DRAWING CROSS-REFERENCE

10—The disclosed invention

12—Complete housing left and right half's of the shell

62L—Left half, exterior housing (shell)

62R—Right half, exterior housing (shell)

14—Interior wall of the left half of the shell

16—First axle

17—First axle support and mounting socket

18—Pulley

20—Bottom of grooved rim of pulley 18

22—Fishing line

24—Second axle

25—Second axle support and mounting socket

26—Idler wheel

28—Idler wheel pivot arm

30—Pivot end of idler wheel pivot arm

32—Wheel end of idler wheel pivot arm

34—Idler wheel axle

36—Idler wheel spring

37—Idler wheel spring support

38—Clock spring

40—First end clock spring

42—Second end clock spring

44—Clock spring housing

45—Attachment slot, second end clock spring

46L—Left guide tube member, reel end

46R—Right guide tube member, reel end

52—Shell opening for fishing line, hook end

54L—Left guide tube member, hook end

54R—Right guide tube member, hook end

58—Shell opening for fishing line, hook end

60—Sinker attachment eyelets

61—Sinker attachment holes

64—Shell hinge pin

66—Shell hinge

68—Pulley latch

70—Pulley latch, engagement end

72—Pulley latch, attachment end

74—Pulley latch button

76—Pulley latch button opening

78—Pulley latch engagement grooves

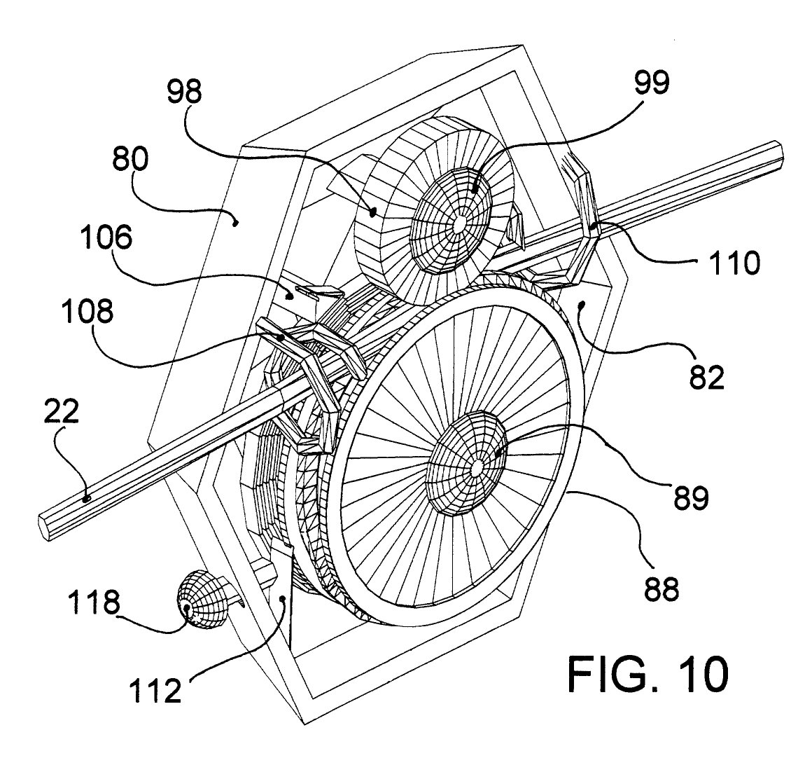

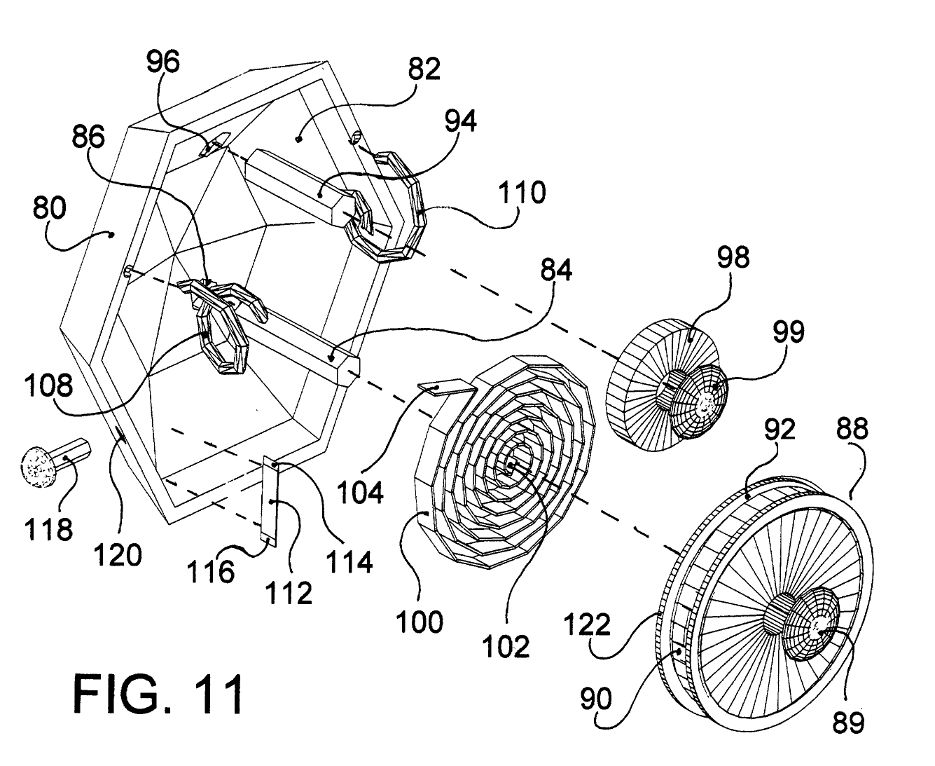

### DRAWING CROSS-REFERENCE, FIGS. 10 AND 11 ONLY

22—Fishing line

80—Shell

82—Interior wall of shell

84—First axle

86—First axle support

88—Pulley

89—Pulley cap

90—Bottom of grooved rim of pulley 88

92—Pulley rim

94—Second axle

96—Second axle support

98—Idler wheel

100—clock spring

102—First end clock sprig

104—Second end clock spring

106—Spring catch

108—guide spring, reel end

110—Guide spring, hook end

112—Pulley latch

114—Pulley latch, engagement end

116—Pulley latch, attachment end

118—Pulley latch button

120—Pulley latch button opening

122—Pulley latch engagement grooves

### DETAILED DESCRIPTION OF THE EMBODIMENTS

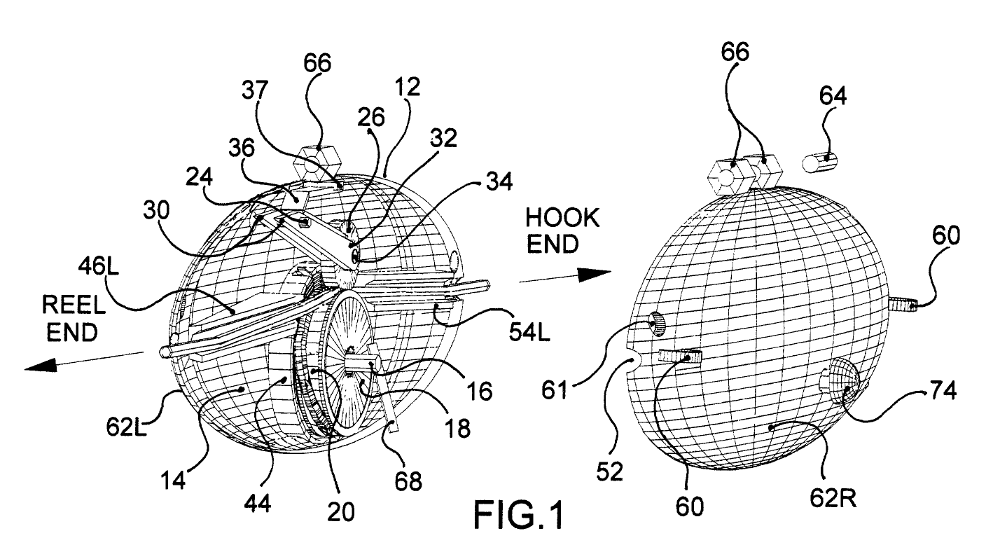

Referring now specifically to the drawings. FIG. 1 shows one of the embodiments of the disclosed apparatus. This embodiment comprises a shell 12 having a first interior wall 14. A first axle 16 is attached to the first wall 14. A first axle support 17 provides a socket for inserting first axle 16, which may be used to provide further support.

Pulley 18 is rotatably mounted on the first axle 16. Pulley 18 has a peripheral surface 20 at the bottom of its grooved rim adapted for engaging the fishing line. The peripheral surface 20 should be made of a material and or texture which is capable of preventing the fishing line 22 from slipping on the pulley 18, when one or more wraps of fishing line have been placed around the pulley. It has been found that a rubber band secured around peripheral surface 20 provides one type of suitable surface for preventing slippage of the fishing line 22. Pulley 18 may also have raised rims 19 to further secure the fishing line 22 onto pulley 18.

As shown in FIG. 1, idler wheel 26 may be mounted on idler wheel arm 28. Idler wheel arm 28 has a pivot end 30 and a wheel end 32. Pivot end 30 is pivotally mounted on second axle 24. Idler wheel 26 may be secured to wheel end 32 by idler wheel axle 34. In this embodiment idler wheel 26 is biased towards pulley 18 with biasing means, such as spring 36, such that the idler wheel engages the peripheral surface 20 of pulley 18. The biasing means, may be nothing more then a thick rubber disk under compression, placed between idler wheel arm 28 on one side and the support 37 on the other side, or a rubber band under tension attached to idler wheel arm 28 on one end and spring housing 44 on the other, or a coil spring under compression placed between idler wheel arm 28 and support 37. For clarity, the biasing means depicted in FIG. 1, is a leaf spring 36, which is shown under compression between idler wheel arm 28 on the one end and spring support 37 on the other end.

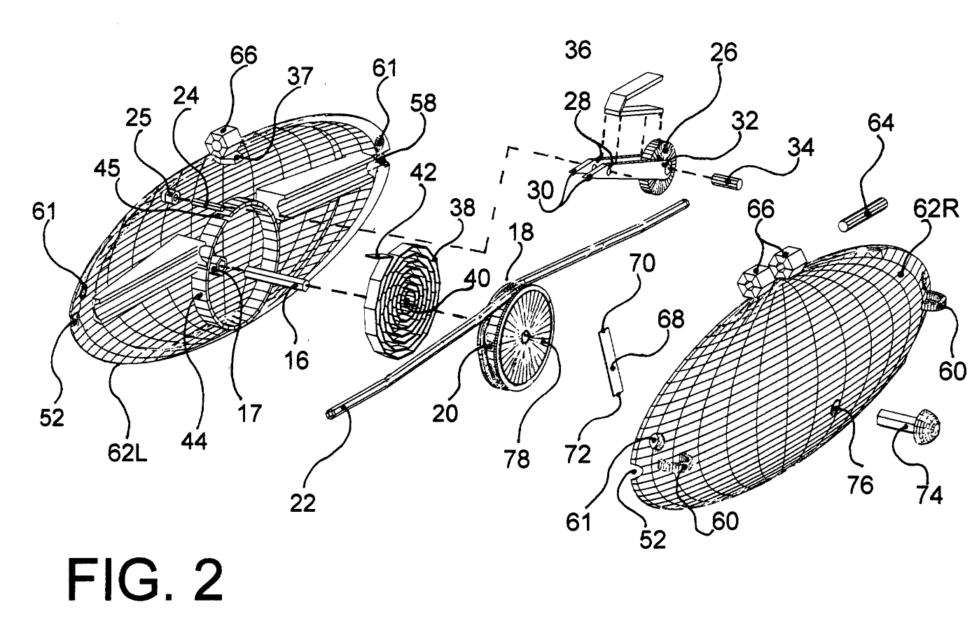

Spring means such as clock spring 38 engages pulley 18, so that the spring tightens as the pulley is rotated in one direction. In FIG. 2, the spring tightens as pulley 18 is rotated in a counter-clockwise direction. Clock spring 38 has a first end 40, at the beginning on the inside of the coil, and a second end 42, at the end on the outside of the coil. First end 40 engages pulley 18, such that first end 40 catches on pulley 18 when the pulley is turn, for the apparatus depicted in FIG. 2, in a counter-clockwise direction. In contrast, first end 40 does not engage pulley 18 when pulley 18 is rotated in a direction opposite to the first direction, which for the apparatus disclosed in FIG. 1 and FIG. 2 is clockwise. When the first end 40 does not engage pulley 18 clock spring 38 is not tightened, and the spring does not appreciably inhibit the rotation of pulley 18. Second end 42 is mounted on available structure on first interior wall 14. One suitable structure is spring housing 44, which confines clock spring 38 and provides attachment slot 45, slot 45 secures second end 42 of spring 38 as pulley 18 is rotated in either direction.

It is to be noted that the particular direction for tightening clock spring 38 depends upon which end of the apparatus 10 is facing the hook and which is facing the reel. It is desired that when the apparatus is placed on fishing line 22 at possession one, with the fishing line wrapped at least once around pulley 18, the spring is tightened when the device moves toward the hook through either manual manipulation by the user or by gravity. When the device is moved in the opposite direction, i.e., towards the reel past possession one, by either the user pulling the fishing line or a hooked fish running, the spring 38 slips and is not tightened, and pulley 18 rotates without clock spring 38 providing appreciable resistance to the rotation. The proper orientation of the device with respect to the reel and hook is depicted with arrows in FIG. 1.

Guiding means guide the fishing line along first interior wall 14 to the pulley 18. The purpose of the guiding means is to convey the fishing line to pulley 18 without the line becoming tangled or bunched up inside the shell 12. Appropriate guiding means may comprise any conduit which serves to enclose fishing line 22, such as tubes, springs, or other cylindrical types of structures.

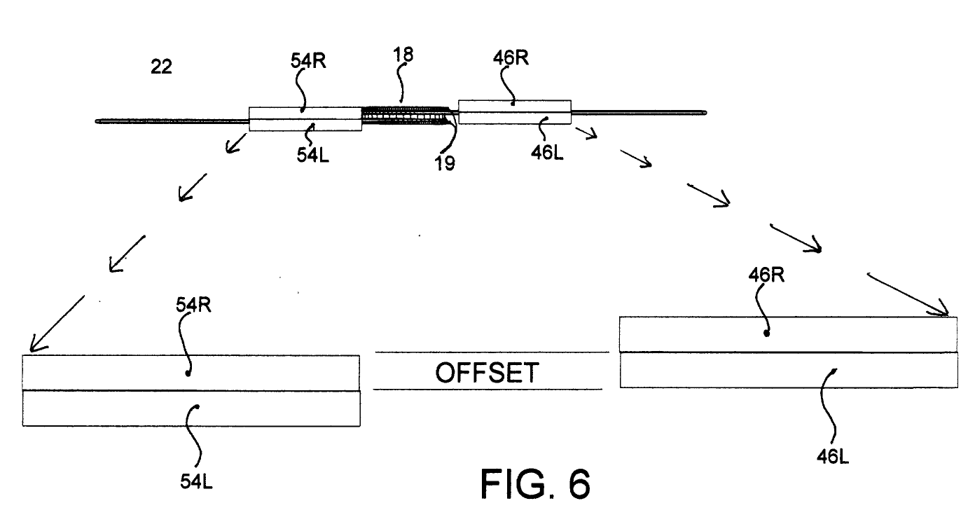

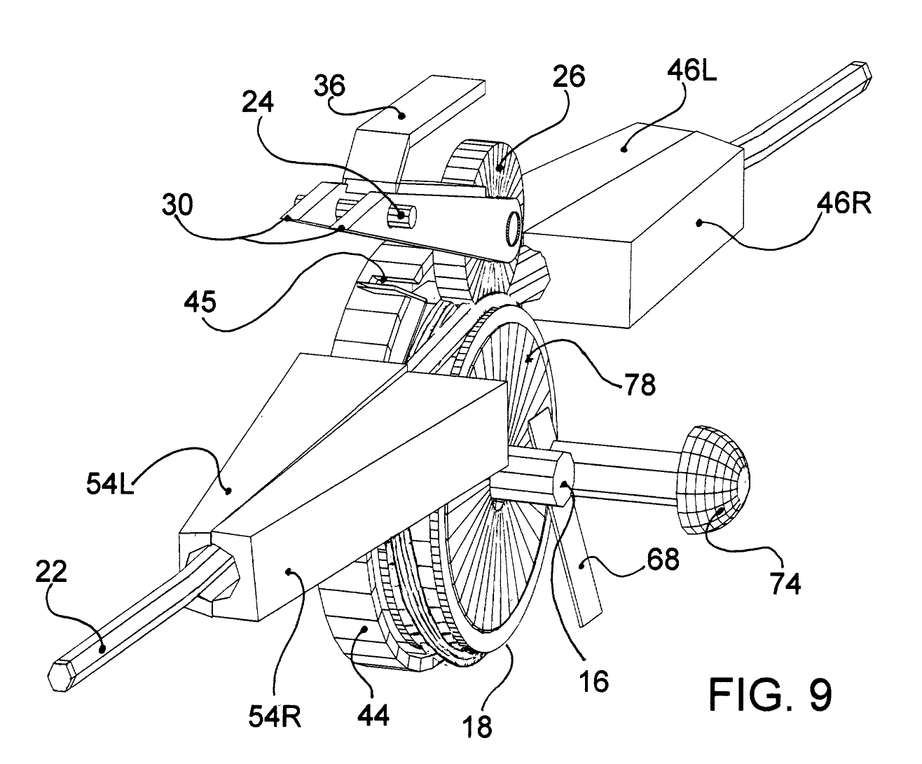

As generally shown in FIG. 1 and FIG. 2 and detailed in FIG. 6 and FIG. 9, the guiding means may comprise a first left guide tube member 46L attached to the first interior wall 14 and a first right guide tube member 46R attached to the second interior wall 48, where, when shell 12 it closed, the first left guide tube member 46L abuts, or alternatively interlocks with the first right guide tube member 46R to form a first conduit 50 for guiding the fishing line 22 from first shell opening 52 to pulley 18. The guiding means further comprises a second left guide tube member 54L attached to the first interior wall 14 and a second right guide tube member 54R attached to the second interior wall 48, where the second left guide tube member 54L abuts, or alternatively interlocks with the second right guide tube member 54R to form a second conduit 56 for guiding the fishing line 22 from second shell opening 58 to pulley 18. Alternatively, as is depicted in FIG. 10 and FIG. 11 the guide tubes may be a spring or some other helical shaped material that will allow the fishing line to be easily loaded into the apparatus with the hook or lure attached prier to attaching the apparatus.

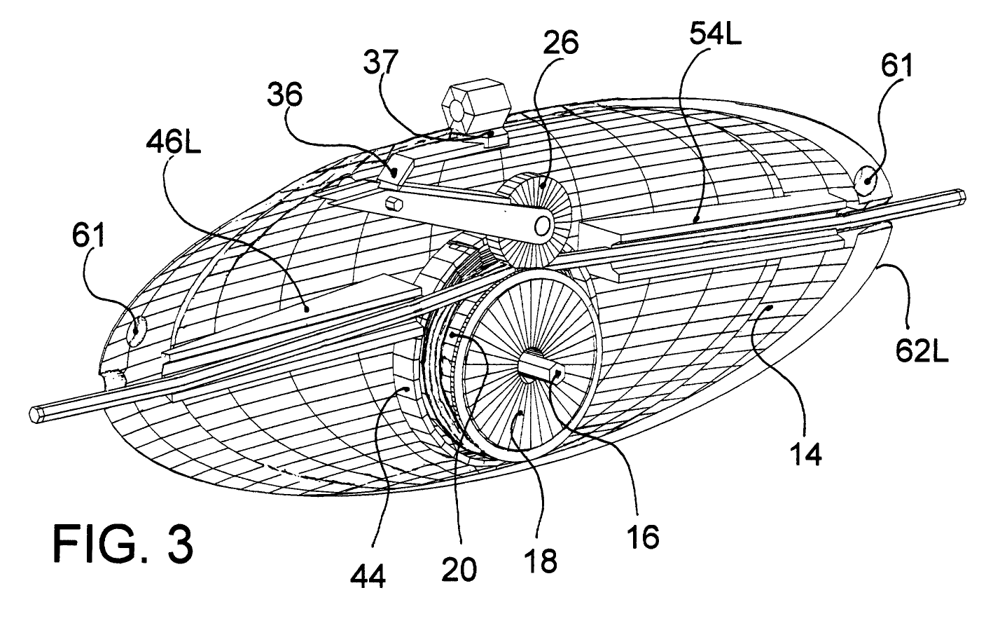

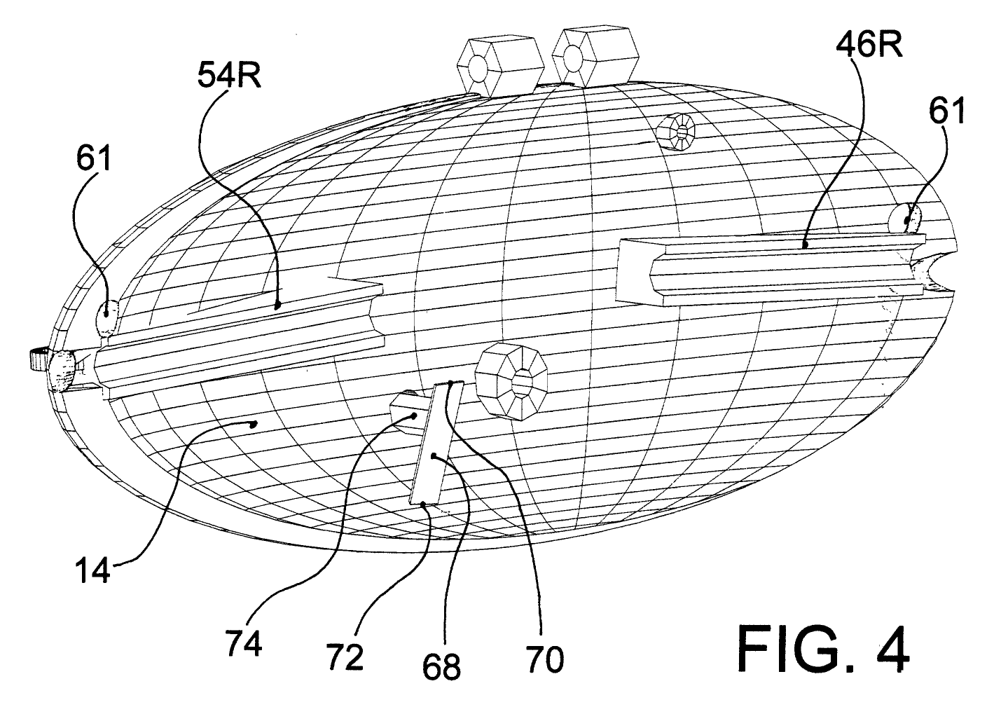

FIG. 3 shows how first left guide tube member 46L and second left guide tube member 54L are mounted in the left shell half 62L. The guide tube members might be fabricated as an integral part of the left shell half 62L through as injection molding process. Likewise, FIG. 4 shows how first right guide tube member 46R and second right guide tube member 54R are mounted in the right shell half 62R, which may be attached or fabricated the save as the components of the left shell half 62L. This configuration of guiding means allows easy loading of the fishing line into the device. Once the shell halves are snapped together, as described below, the first left guide tube member 46L and the first right guide tube member 46R from a complete tube, i.e., first conduit 50 enclosing the fishing line 22. Likewise, second left guide tube member 54L and second right guide tube member 54R form a complete tube, i.e. second conduit 56 enclosing the fishing line. As shown in FIG. 6, first conduit 50 is offset from second conduit 56 to keep the fishing line 22 from crossing over itself on pulley 18 and fouling or tangling the line.

It is to be noted that the apparatus itself may serve as a sinker, depending upon the amount of weight required and the weight of the materials used to manufacture the apparatus. However. In some cases the user may wish to have a sinker weighing more then the apparatus alone, so the apparatus may further comprise means for adding weight to it. For the embodiment disclosed in FIG. 1, such means include attaching one or more eyelets 60 to the shell 12. Other means include placing sinker attachment holes 61 in various positions on the shell 12, or sinkers may be molded to fill the unused cavities within shell 12.

The shell 12 may comprise a first half 62L attached to a second half 62R by connecting hinge 66, where first half 62L has first interior wall 14 and second half 62R has second interior wall 48, first interior wall 14 disposed in facing relation when the shell 12 is in a closed position. Any number of fastening means may be used to hold first half 62L and second half 62R, closed once assembled such as friction pin and socket connectors, elastic bands, screws, snap latch, or any combination of the identified fastening means, or others known in the art. Because the user must open the shell 12 to wrap the fishing line around the pulley 18, the choice of fastening means should consider the ease with which the shell may be opened by the user.

It should be noted that the shell 12 may comprise almost any shape capable of holding the components of the apparatus in a useable configuration. However, for appearance, ease of manufacture, and for reducing drag as the device is placed into, used, and removed from the water, a shell in the shape of an ellipsoid is a reasonable selection.

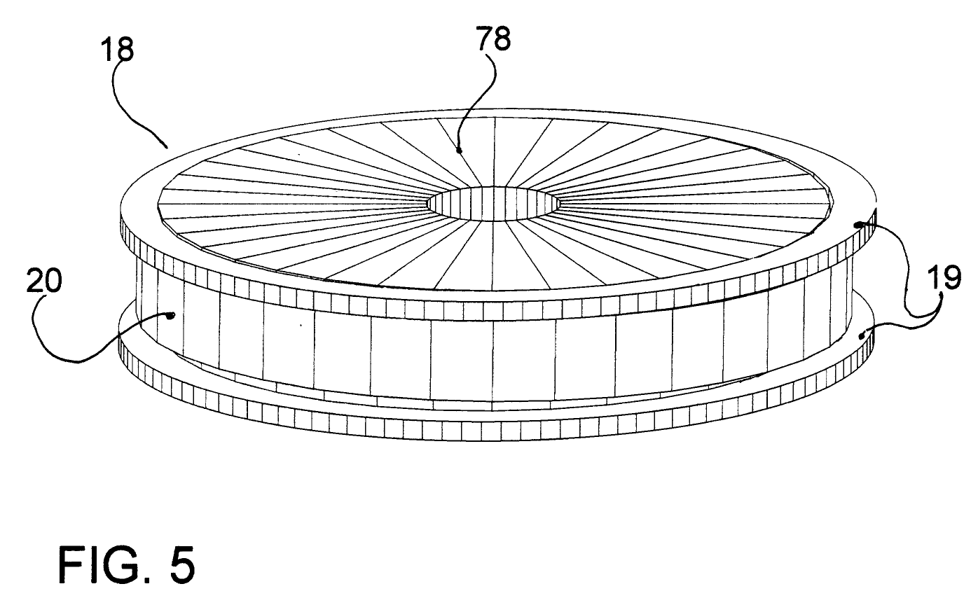

In one embodiment, the apparatus comprises latching means for temporarily restraining pulley 18 and clock spring 38 in the tightened position. One means of temporarily restraining pulley 18 employs pulley latch member 68. Pulley latch member 68 has an engagement end 70 and an attachment end 72. Attachment end 72 attaches to second interior wall 48. The pulley latch is constructed of materials and has sufficient length to allow engagement end 70 to sufficiently deflect to engage pulley 18. Engagement end 70 is pushed toward pulley 18 by pulley latch button 74, which extends through button opening 76 of second half 62R to second interior wall 48. Latch button 74 pushes the engagement end 70 to engage the pulley 18. As indicated on FIG. 2 and FIG. 5, the side of pulley 18 may include engagement grooves 78 which engagement end 70 may engage to temporarily restrain pulley 18 from rotating. Alternatively, engagement end 70 may be sharpened allowing it to grip a smother surface negating the need for engagement grooves 78.

The embodiment with the latching means may be used for casting, particularly where a long leader is desired between the sinker and the hook. Typically, casting with a long leader between the sinker and hook is dangerous and difficult, if not impossible, because the sinker is stopped at the first eyelet of the fishing pole and the leader and the hook or lure hang down from the tip of the pole. Many angler each year end up hooking themselves, or an innocent bystander while attempting to cast using long leaders. The disclosed apparatus solves this problem by automatically moving from a position adjacent to the hook, fore ease of casting, to a preselected position further up the line once the cast has been made.

An alternative embodiment of the invention is shown in FIG. 10 and FIG. 11 This embodiment comprises a shell 80 having a first interior wall 82. A first axle 84 is attached to the first wall 82. A first axle support 86 provides a socket for inserting first axle 84, which may be used to provide further support. Pulley 88 is rotatably mounted on the first axle 84. Pulley 88 has a peripheral surface 90 at the bottom of its grooved rim, adapted for engaging the fishing line. The peripheral surface 90 should be of a texture which is capable of preventing the fishing line 22 from slipping on the pulley 88, when one or more wraps of fishing line have been placed around the pulley. It has been found that a rubber band secured around peripheral surface 90 provides a suitable texture for preventing slippage of the fishing line 22. Alternatively. The peripheral surface might be fabricated from any material that will provide suitable traction for the fishing line and yet will not damage the fishing line in doing so. Pulley 88 may also have raised rims 92 to further secure the fishing line 22 onto the pulley 88. Pulley 88 is locked on first axle 84 with pulley cap 89. Second axle 94 is attached to the first interior wall 82. A second axle support 96, which provides a socket for inserting second axle 94, may be used to further support the second axle 94. Idler wheel 98 may be attached directly to second axle 94, where the idler wheel is mounted such that to rotates freely on the second axle. In this embodiment, second axle 94 is adjacent to pulley 88. Idler wheel 98 should be comprised of a soft material, such as rubber, such that fishing line 22 is engaged between the idler wheel and pulley 88. Idler wheel 98 is locked on second axle 94 with idler wheel cap 99.

Spring means such as clock spring 100 engage pulley 88, so that the spring means tightens as the pulley is rotated in one direction. In FIG. 11, the spring means tightens as pulley 88 is rotated in a counter-clockwise direction. Clock spring 100 has a first end 102, at the beginning on the inside of the coil, and a second end 104 at the end on the outside of the coil. First end 102 engages pulley 88, such that first end 102 catches on pulley 88 when the pulley is turned, for the apparatus depicted in FIG. 10 and FIG. 11, in a counter-clockwise direction, In contrast, first end 102 does not engage any structure when pulley 88 is rotated in a direction opposite to the first direction, which for the apparatus disclosed in FIG. 10 and FIG. 11 is clockwise. When the first end 102 does not engage pulley 88 clock spring 100 is not tightened, and the spring does not appreciably inhibit the rotation of pulley 88. Second end 104 is attached to available structure on first interior wall 82. One suitable structure is spring catch 106, which provides a structure to attach second end 104.

Guiding means guide the fishing line along first interior wall 82 to the pulley 88. The purpose of the guiding means is to convey the fishing line to pulley 88 without the line becoming tangled or bunched up inside the shell 80. appropriate guiding means may comprise any conduit which serves to enclose fishing line 22, such as tubes, springs, or other enclosing types of structures. As shown in FIG. 10 and FIG. 11, the guiding means may comprise a first guide coil 108 and second guide coil 110 which are mounted to shell 80.

As shown in FIG. 10 and FIG. 11, as an addition to this embodiment, the apparatus may further comprise latching means for temporarily restraining pulley 88 and clock spring 100 in the tightened position. One means of temporarily restraining the pulley 88 employs pulley latch member 112. Pulley latch member 112 has an engagement end 114 and an attachment end 116. Attachment end 116 attaches to an inside edge of shell 80. The pulley latch member 112 is constructed of materials and has sufficient length to allow engagement end 114 to sufficiently deflect to engage pulley 88. Engagement end 114 is pushed toward pulley 88 by pulley latch button 118, which extends through opening 120 in shell 80. Latch button 118 pushes the engagement end 114 to engage the pulley 88. as indicated on FIG. 10 and FIG. 11, the rims 92 of pulley 88 may include engagement grooves 122 which engagement end 114 may engage to temporarily restrain pulley 88 from rotating. Alternatively engagement end 114 may be sharpened allowing it to grip smother surfaces negating the need for engagement grooves 122.

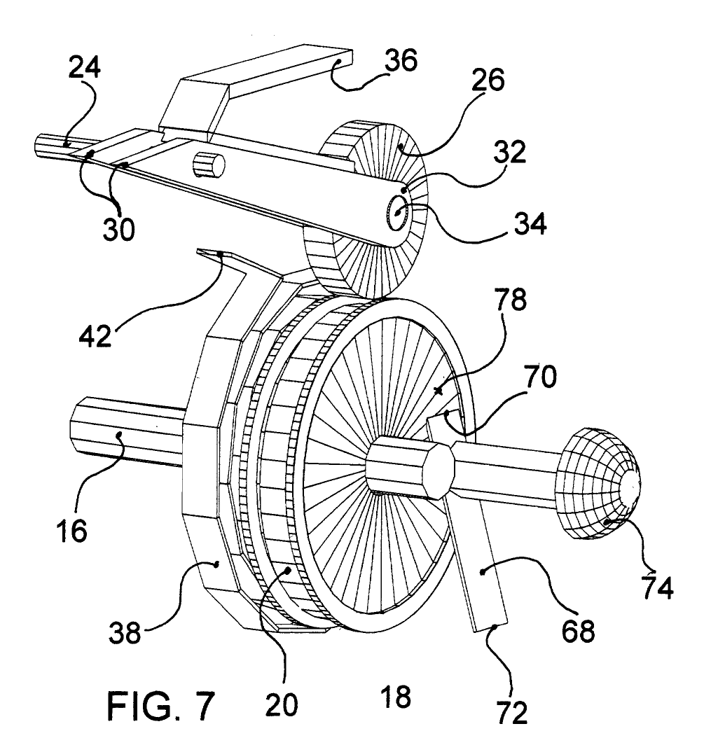

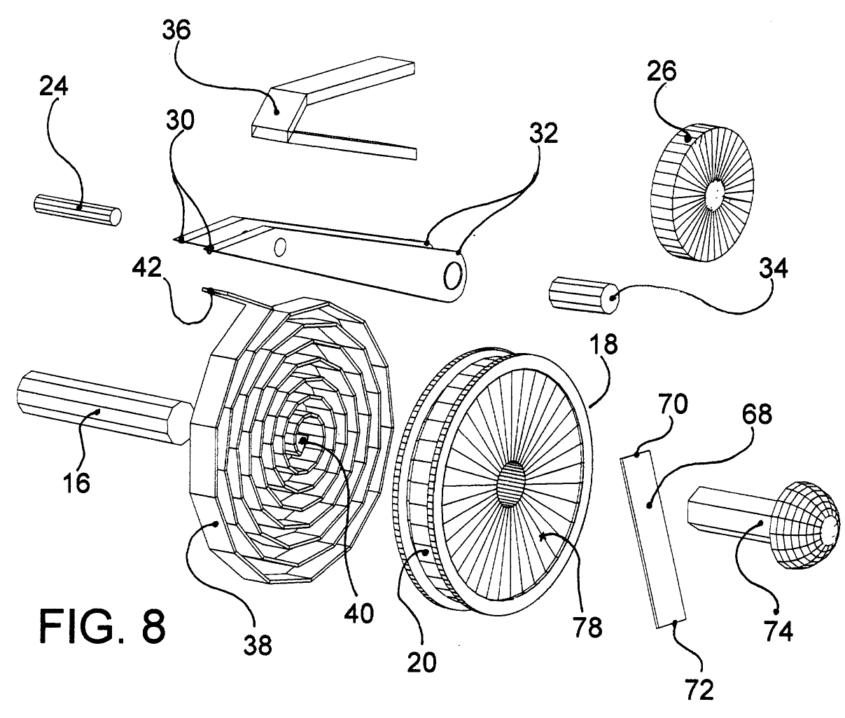

Using the embodiment disclosed in FIGS. 1 through 9 as an example, either alone or with additional weight enclosed or sinkers attached, the apparatus is placed on the fishing line 22 a preselected distance above a hook at a first position, with one or more wraps of fishing line placed around pulley 18. The apparatus is then pulled down the fishing line 22 adjacent to the hook, to a second position. Pulling the apparatus down the fishing line to the second position causes pulley 18 to rotate thus tightening clock spring 38, creating a source of potential energy. When the apparatus is at the second position, pulley latch button 74 so pushed, causing the engagement end 70 of pulley latch member 68 to engage one of the engagement grooves 78 of the pulley 18. The force applied to the apparatus during the cast will cause the engagement end 70 to disengage from the pulley 18. Once the latch is disengaged, the tightened spring causes pulley 18 to rotate, such that the apparatus moves up the fishing line away from the hook to approximately the first position on the fishing line 22.

When held vertically and motionless, suspended in the water, the disclosed apparatus either alone or with weight attached maintains a preselected distance above the bait or lure, yet allows the fishing line 22 to be pulled through the device when the line is jerked up, such as during a jigging operation or when setting a hook. While this motion causes the spring means, such as clock spring 38, to tighten, the energy, and the time required to tighten the spring is substantially less than that required to pull up weights which are attached directly to the fishing line as when jigging with conventional tackle. Tightening a spring not only requires less force then pulling a weighted mass through the water but allows a much faster, sharper motion which is essential when an angler is attempting to simulate pray such as bait fish.

The disclosed apparatus may also be used as a trolling weight holder or when fishing fast running water, such as rivers and streams, where the orientation of the device is closer to horizontal then vertical. Use of the device allows the angler to manipulate the bait or lure in a manner not possible with conventional tackle.

While the above is a description of various embodiments of the present invention, further modifications may be employed without departing from the spirit and scope of the present invention. For example the size, shape, and or material of the various components may be changed as desired. Thus the scope of the invention should not be limited by the specific structures disclosed. Instead the true scope of the invention should be determined by the following claims.

What is claimed is:

1. A fishing apparatus attachable to a fishing line, the apparatus comprising:
(a) a shell having a first wall;
(b) a first axle attached to the first wall;
(c) a pulley rotatably mounted on the first axle, the pulley having a peripheral surface at the bottom of its grooved rim adapted for engaging the fishing line;
(d) a second axle attached to the first wall adjacent to the pulley;
(e) an idler wheel rotatably mounted on the second axle, the idler wheel engaging the peripheral surface at the bottom of the grooved rim of the pulley;
(f) spring means engaging the pulley, said spring means placed in a tightened position upon rotation of the pulley in the first direction but said spring means not tightening upon rotation of the pulley in a direction opposite to the first direction; and
(g) guiding means for guiding the fishing line along the first wall to the pulley.

2. The apparatus of claim 1, further comprising means for adding weight to the apparatus.

3. The apparatus of claim 2 wherein the means for adding weight to the apparatus comprises an eyelet attached to the shell, the eyelet adaptable for attaching a fishing weight.

4. The apparatus of claim 2 wherein the means for adding weight to the apparatus comprises the shell having sinker attachment holes.

5. The apparatus of claim 1 further comprising a first socked attached to the first wall, the first socket adapted for support of the first axle.

6. The apparatus of claim 1 further comprising a second socket attached to the first wall, the second socket adapted for support of the second axle.

7. The apparatus of claim 1 further comprising a second socket attached to the first wall.

8. The apparatus of claim 7 wherein the spring means comprises a clock spring having a first end and a second end, the first end attached to the spring housing and the second end engaging the pulley when the pulley is rotated in the first direction.

9. A fishing apparatus attachable to a fishing line, the apparatus comprising:
(a) a shell comprising a first half attached to a second half by hinge means on the one side and s fasting means on the other, the first half having a first interior wall and the second half having a second interior wall, the shell having openings for passing fishing line into and out of the shell;
(b) a first axle attached to the first interior wall;
(c) a pulley rotatably mounted on the first axle, the pulley having a peripheral surface at the bottom of its grooved rim adapted for engaging the fishing line;
(d) a second axle attached to the first interior wall adjacent to the pulley;
(e) an idler wheel rotatably mounted on the second axle, the idler wheel engaging the peripheral surface at the bottom of the grooved rim of the pulley;
(f) spring means engaging the pulley, said spring means placed in a tightened position upon rotation of the pulley in a first direction but said spring means not tightening upon rotation of the pulley in a direction opposite to the first direction; and
(g) guiding means for guiding the fishing line through the shell to the pulley so that the fishing line may be wrapped around the pulley and the fishing line engaged between the idler wheel and the pulley.

10. The apparatus of claim 9, further comprising means for adding weight to the apparatus.

11. The apparatus of claim 10 wherein the means for adding weigh to the apparatus comprises an eyelet attached to the shell, the eyelet adaptable for attaching a fishing weight.

12. The apparatus of claim 10 wherein the means for adding weight to the apparatus comprises the shell having sinker attachment holes.

13. The apparatus of claim 10 wherein the means for adding weight comprises a space defined by the first interior wall on one side and the second interior wall on the other side.

14. The apparatus of claim 9 wherein the shell is an ellipsoid.

15. The apparatus of claim 9 wherein the fastening means comprises a pinned hinge on the one side and any number of fastening means on the other such as friction pin and socket connector, elastic bands, screws or snap latch.

16. The apparatus of claim 9 further comprising latching means for temporarily restraining the pulley and spring means in the tightened position.

17. The apparatus of claim 9 further comprising a spring housing attached to the first interior wall.

18. The apparatus of claim 17 wherein the spring means comprises a clock spring having a first end and a second end, the first end engaging the pulley when the pulley is rotated in the first direction and the second end attached to the spring housing.

19. A fishing apparatus attachable to a fishing line, the apparatus comprising:
(a) a shell comprising a first half attached to a second half with hinge means on the one side and any number of fastening means on the other such as friction pin and socket connectors elastic bands, screws, snap latch or any combination thereof;
(b) the first half having a first interior wall and the second half having a second interior wall, the shell having openings for passing fishing line into the out of the shell;
(c) a first axle attached to the first interior wall;
(d) a pulley rotatably mounted on the first axle, the pulley having a peripheral surface adapted for engaging fishing line;
(e) a second axle attached to the first interior wall;
(f) an idler wheel arm having a pivot end and a wheel end, the pivot end pivotally mounted on the second axle;
(g) an idler wheel rotatably attached to the wheel end of the idler wheel arm;
(h) biasing means for maintaining the idler wheel in contact with the peripheral surface to the bottom of the grooved rim of the pulley;
(i) spring means engaging the pulley, said spring means placed in a tightened position upon rotation of the pulley in the first direction but said spring means not tightening upon rotation of the pulley in a direction opposite to the first direction;
(j) guiding means for guiding the fishing line through the shell to the pulley so that the fishing line may be wrapped around the pulley and the fishing line engaged between the idler wheel and the pulley.

20. The apparatus of claim 19 wherein the biasing means comprises a spring disposed between the idler wheel arm and first interior wall.

21. The apparatus of claim 1, further comprising means for adding weight to the apparatus.

22. The apparatus of claim 21 wherein the means for adding weight to the apparatus comprises an eyelet attached to the shell, the eyelet adaptable for attaching a fishing weight.

23. The apparatus of claim 21 wherein the means for adding weight to the apparatus comprises the shell having sinker attachment holes.

24. The apparatus of claim 21 wherein the means for adding weight comprises a space defined by the first interior wall on the side and the second interior wall on the other side.

25. The apparatus of claim 19 wherein the shell is an ellipsoid.

26. The apparatus of claim 19 wherein the fastening means comprised a pinned hinge on the one side and any number of conventional latching means on the other.

27. The apparatus of claim 19 further comprising latching means for temporarily restraining the pulley and spring means in the tightened position.

28. The apparatus of claim 19 further comprising a spring housing attached to the first interior wall.

29. The apparatus of claim 28 wherein the spring means comprises a clock spring having a first end and a second end, the first end engaging the pulley when the pulley is rotated in the first direction and the second end is attached to the spring housing.

30. A fishing apparatus attachable to a fishing line between the fishing reel on one side and the fishing hook on the other side, the apparatus comprising:
(a) a shell having a reel end facing the fishing reel and a hook end facing the hook, the shell having a first opening in the reel end and a second opening in the hook end, the first and second openings for passing fishing line into and out of the shell, the shell comprising a first half attached to a second half with a plurality of pinned hinges, the first half having a first interior wall and the second half having a second interior wall;
(b) a plurality of eyelets attached to the shell, the eyelets adapted for attaching fishing weights;
(c) a first axle attached to the interior wall;
(d) a pulley rotatably mounted on the first axle, the pulley having a;
peripheral surface at the bottom of its grooved rim adapted for engaging fishing line;
(e) a second axle attached to the first interior wall;
(f) an idler wheel arm having a pivot end and a wheel end, the pivot end pivotally mounted on the second axle;
(g) an idler wheel rotatably attached to the wheel end of the idler wheel arm;
(h) biasing means for maintaining the idler wheel in contact with the peripheral surface at the bottom of the grooved rim of the pulley;
(i) a spring housing attached to the first interior wall;
(j) a clock spring having a first end and a second end, the first end engaging the pulley when the pulley is rotated in the first direction such that the clock spring is placed in tightened position, but said clock spring is not tightened upon rotation of the pulley in a direction opposite to the first direction. The second end of the clock spring is attached to the spring housing;
(k) a first guide tube comprising a first left guide tube member attached to the first interior wall and a first right guide tube member attached to the second interior wall, where the first left guide tube member abuts the first right guide tube member to form a first conduit for guiding fishing line from the first opening to the pulley;
(l) a second guide tube comprising a second left guide tube member attached to the first interior wall and a second right guide tube member attached to the second interior wall, where the second left guide tube member abuts the second right guide tube member to form a second conduit for guiding fishing line from the second opening to the pulley;
(m) a pulley latch member having a pivot end and an attachment end, the attachment end attached to the second interior wall and the engagement end adaptable for engaging the pulley; and
(n) a pulley latch button extending through the second half to the second interior wall, the latch button pushing the engagement end for the pulley latch member to engage the pulley.
